(19) United States
(12) Patent Application Publication
(10) Pub. No.: US 2023/0318382 A1
(43) Pub. Date: Oct. 5, 2023

(54) STATOR AND MOTOR

(71) Applicant: Komatsu Ltd., Tokyo (JP)

(72) Inventors: Hiroki Hijikata, Tokyo (JP); Natsuki Watanabe, Tokyo (JP)

(73) Assignee: Komatsu Ltd., Tokyo (JP)

(21) Appl. No.: 18/021,194

(22) PCT Filed: Sep. 17, 2021
(86) PCT No.: PCT/JP2021/034416

§ 371 Date: Feb. 14, 2023

(30) Foreign Application Priority Data
Sep. 18, 2020 (JP) 2020-157219

(51) Int. Cl. H02K 3/28; H02K 3/52

(52) U.S. Cl. CPC H02K 3/28; H02K 3/522; H02K 2203/09

(57) ABSTRACT

A stator capable of controlling an increase in a size of a motor is provided. The stator includes a stator core and coils. The stator core includes mounted teeth on which the coils are mounted and non-mounted teeth on which the coils are not mounted. Each of the coils includes a coil end portion that protrudes in an axial direction from the stator core, and a terminal portion connected to a connecting wire that connects the coils to each other. The terminal portion protrudes in a circumferential direction from the coil end portion in such a manner as to overlap with at least a part of the non-mounted teeth in the axial direction.

### FIELD

The present disclosure relates to a stator and a motor.

### BACKGROUND

A stator of a motor includes a stator core, a plurality of coils mounted on the stator core, and a connecting wire that connects the plurality of coils. Patent Literature 1 discloses a cassette coil having a terminal portion connected to a bus bar.

### CITATION LIST

### Patent Literature

Patent Literature 1: JP 2009-100626 A

### SUMMARY

### Technical Problem

Downsizing of a motor is required. In a case of controlling a size of the motor in an axial direction, it is effective to control a size of a stator in the axial direction.

An object of the present disclosure is to control an increase in the size of the motor.

### Solution to Problem

According to an aspect of the present invention, a stator comprises: a stator core; and coils, wherein the stator core includes mounted teeth on which the coils are mounted and non-mounted teeth on which the coils are not mounted, each of the coils includes a coil end portion that protrudes in an axial direction from the stator core, and a terminal portion connected to a connecting wire that connects the coils to each other, and the terminal portion protrudes in a circumferential direction from the coil end portion in such a manner as to overlap with at least a part of the non-mounted teeth in the axial direction.

### Advantageous Effects of Invention

According to the present disclosure, an increase in a size of a motor is controlled.

### BRIEF DESCRIPTION OF DRAWINGS

FIG. 1 is a view schematically illustrating a motor according to a first embodiment.

FIG. 2 is a perspective view illustrating a stator according to the first embodiment.

FIG. 3 is a side view illustrating the stator according to the first embodiment.

FIG. 4 is an enlarged view of a part of the stator according to the first embodiment.

FIG. 5 is a perspective view illustrating the stator, in which connecting wires are provided, according to the first embodiment.

FIG. 6 is a view schematically illustrating a connection state of coils according to the first embodiment.

FIG. 7 is an enlarged view of a part of the stator, in which the connecting wires is provided, according to the first embodiment.

FIG. 8 is a schematic diagram illustrating a flow of a magnetic flux according to the first embodiment.

FIG. 9 is a schematic diagram illustrating a flow of a magnetic flux according to a comparison example.

FIG. 10 is a perspective view illustrating a stator according to the second embodiment.

FIG. 11 is a perspective view illustrating a coil set according to the second embodiment.

### DESCRIPTION OF EMBODIMENTS

In the following, embodiments according to the present disclosure will be described with reference to the drawings. However, the present disclosure is not limited to the embodiments. Components of the embodiments described in the following can be arbitrarily combined. In addition, there is a case where a part of the components is not used.

### First Embodiment

The first embodiment will be described.

<Motor>

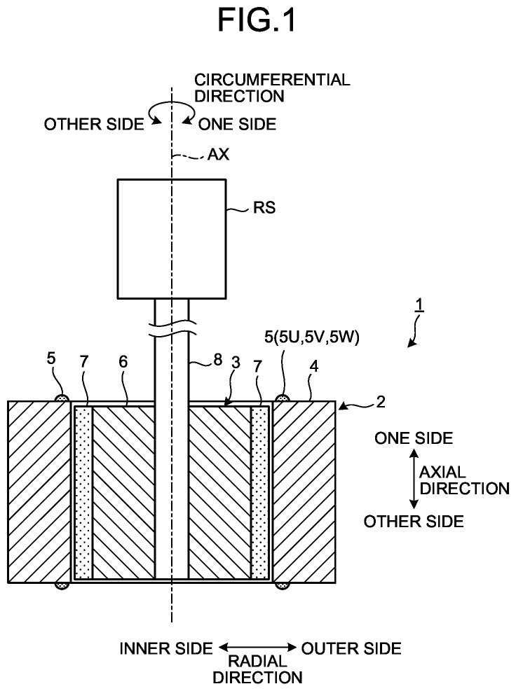

FIG. 1 is a view schematically illustrating a motor 1 according to the embodiment. In the embodiment, the motor 1 is a switched reluctance motor. As illustrated in FIG. 1, the motor 1 includes a stator 2 and a rotor 3.

The motor 1 is an inner rotor type. The stator 2 is arranged around the rotor 3. The rotor 3 faces the stator 2. The rotor 3 rotates about a rotation axis AX.

In the embodiment, a direction parallel to the rotation axis AX is appropriately referred to as an axial direction, a direction around the rotation axis AX is appropriately referred to as a circumferential direction, and a radiation direction of the rotation axis AX is appropriately referred to as a radial direction.

A direction or a position separated from a center of the motor 1 in a prescribed direction in the axial direction is appropriately referred to as one side in the axial direction, and an opposite side in the axial direction of the one side in the axial direction is appropriately referred to as the other side in the axial direction. A prescribed direction in the circumferential direction is appropriately referred to as one side in the circumferential direction, and an opposite side in the circumferential direction of the one side in the circumferential direction is appropriately referred to as the other side in the circumferential direction. A direction or a position separated from the rotation axis AX in the radial direction is appropriately referred to as an outer side in the radial direction, and an opposite side in the radial direction of the outer side in the radial direction is appropriately referred to as an inner side in the radial direction.

The stator 2 includes a stator core 4 and a coil 5. The stator core 4 is arranged around the rotation axis AX. The coil 5 is mounted on the stator core 4.

The rotor 3 is arranged on the inner side of the stator core 4. The rotor 3 includes a rotor holder 6, a rotor core 7, and a rotor shaft 8. The rotor holder 6 is a non-magnetic body. The rotor core 7 is a magnetic body. The rotor core 7 is held by the rotor holder 6. The rotor core 7 functions as a pole of the rotor 3.

The rotor 3 is connected to an object RS via the rotor shaft 8. Examples of the object RS include an engine mounted on a hybrid excavator that is a kind of construction machine. The motor 1 functions as a generator driven by the engine.

<Stator>

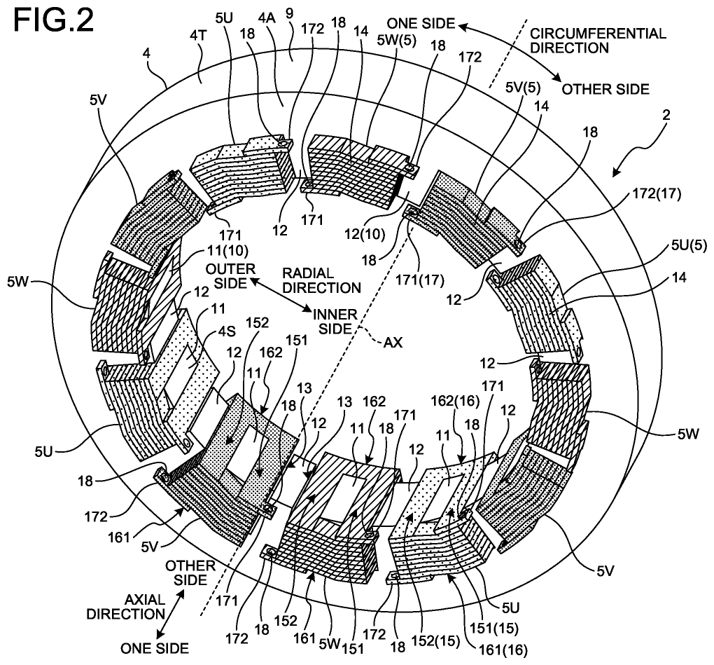

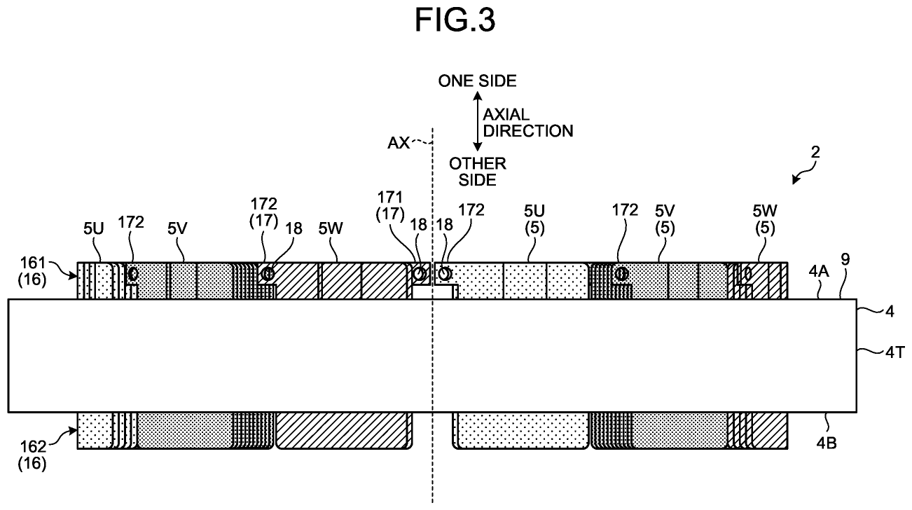

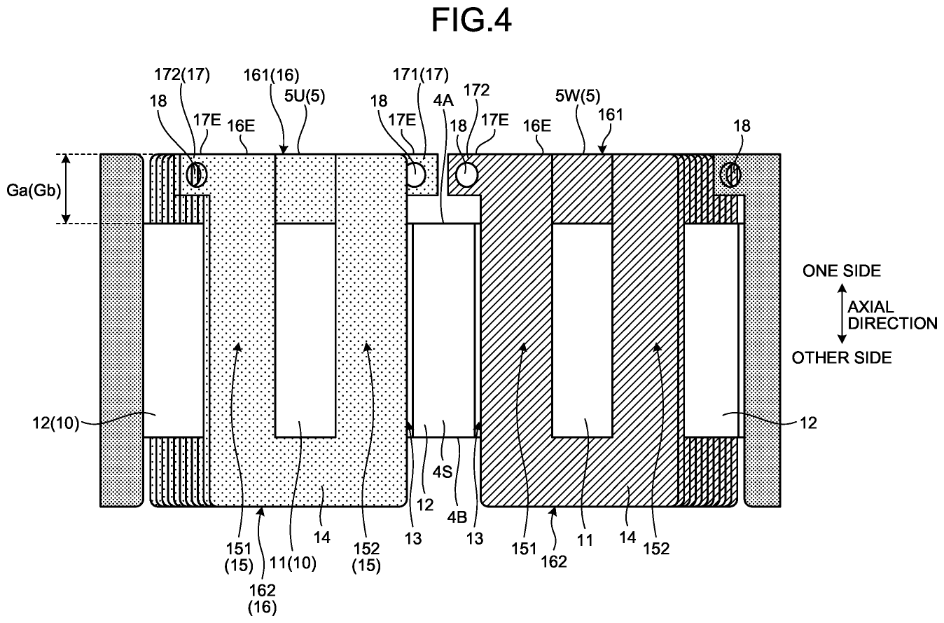

FIG. 2 is a perspective view illustrating the stator 2 according to the embodiment. FIG. 3 is a side view illustrating the stator 2 according to the embodiment. FIG. 4 is an enlarged view of a part of the stator 2 according to the embodiment. The part of the stator 2 as viewed from the inner side in the radial direction is illustrated in FIG. 4.

The stator core 4 includes a plurality of stacked steel plates. The stator core 4 includes a yoke 9 and teeth 10. The yoke 9 is arranged around the rotation axis AX. The yoke 9 has a tubular shape centered on the rotation axis AX. The yoke 9 has a circular outer shape in a plane orthogonal to the rotation axis AX. The teeth 10 protrude to the inner side in the radial direction from an inner surface of the yoke 9. The plurality of teeth 10 is arranged at intervals in the circumferential direction. In the embodiment, 24 teeth 10 are provided. In the embodiment, shapes of the plurality of teeth 10 are the same. Sizes of the plurality of teeth 10 are equal. The plurality of teeth 10 is arranged at equal intervals in the circumferential direction. Note that the shapes of the plurality of teeth 10 may not be the same. The sizes of the plurality of teeth 10 may not be the equal. The plurality of teeth 10 may be arranged at unequal intervals in the circumferential direction.

Surfaces of the stator core 4 include an end surface 4A, an end surface 4B, an inner surface 4S, and an outer surface 4T.

The end surface 4A faces the one side in the axial direction. The end surface 4A includes an end surface of the yoke 9 which surface faces the one side in the axial direction, and end surfaces of the teeth 10 which surfaces face the one side in the axial direction. The end surface of the yoke 9 and the end surfaces of the teeth 10 are flush with each other. The end surface 4A and an axis parallel to the rotation axis AX are orthogonal to each other.

The end surface 4B faces the other side in the axial direction. The end surface 4B includes an end surface of the yoke 9 which surface faces the other side in the axial direction, and end surfaces of the teeth 10 which surfaces face the other side in the axial direction. The end surface of the yoke 9 and the end surfaces of the teeth 10 are flush with each other. The end surface 4B and an axis parallel to the rotation axis AX are orthogonal to each other.

The inner surface 4S faces the inner side in the radial direction. The inner surface 4S includes inner surfaces of the teeth 10. The inner surface 4S faces the rotor 3. The inner surface 4S is parallel to the rotation axis AX.

The outer surface 4T faces the outer side in the radial direction. The outer surface 4T includes an outer surface of the yoke 9. The outer surface 4T is parallel to the rotation axis AX. In a plane orthogonal to the rotation axis AX, the outer surface 4T has a circular shape centered on the rotation axis AX.

The coil 5 is mounted on the stator core 4 via an insulator (not illustrated). A plurality of the coils 5 is provided. The plurality of coils 5 is formed separately. In the embodiment, the coils 5 are so-called cassette coils. Each of the coils 5 is formed by winding of one conductor 14 in a spiral shape. Examples of the spirally wound conductor 14 include a square wire, a rectangular wire, and a round wire. Note that each of the coils 5 may be formed by connection of a plurality of conductors 14 in a spiral shape. Examples of the conductors 14 connected in the spiral shape include a plate-shaped segment conductor.

In the embodiment, it is assumed that the conductor 14 that forms the coils 5 is the rectangular wire. Note that the conductor that forms the coils 5 may be a plate-shaped segment conductor.

The coils 5 are mounted on the teeth 10. A slot 13 is provided between the adjacent teeth 10. A plurality of the slots 13 is provided in the circumferential direction. In the embodiment, 24 slots 13 are provided. The slots 13 extend in the axial direction. Ends on the one side in the axial direction of the slots 13 are connected to the end surface 4A. Ends on the other side in the axial direction of the slots 13 are connected to the end surface 4B. A part of the coils 5 is arranged in the slots 13. A part of the coils 5 protrudes in the axial direction from the stator core 4.

The coils 5 are mounted on some of the teeth 10 among the plurality of teeth 10. The teeth 10 include mounted teeth 11 on which the coils 5 are mounted and non-mounted teeth 12 on which the coils 5 are not mounted.

In the embodiment, the mounted teeth 11 and the non-mounted teeth 12 are alternately arranged one by one in the circumferential direction.

In the embodiment, a winding method of the coils 5 is concentrated winding in which one coil 5 is mounted on one mounted tooth 11. That is, the coils 5 are mounted on the stator core 4 at a pitch of one slot. Furthermore, the winding method of the coils 5 is a single layer winding in which one coil 5 is arranged in one slot 13. Each of the non-mounted teeth 12 is arranged between two coils 5 adjacent to each other in the circumferential direction.

Each of the coils 5 includes a coil main body 15, a coil end portion 16, and a terminal portion 17. The coil main body 15 is arranged in the slot 13. The coil end portion 16 protrudes in the axial direction from the stator core 4. The terminal portion 17 protrudes in the circumferential direction from the coil end portion 16.

A pair of the coil main bodies 15 is provided in the coil 5. The coil main bodies 15 include a first coil main body 151 and a second coil main body 152. In a case where the first coil main body 151 is arranged in a predetermined slot 13, the second coil main body 152 is arranged in a slot 13 one slot away from the slot 13 in which the first coil main body 151 is arranged. Each of the non-mounted teeth 12 is arranged between the first coil main body 151 of one of the two coils 5 adjacent to each other in the circumferential direction and the second coil main body 152 of the other coil 5.

A pair of the coil end portions 16 is provided in each of the coils 5. The coil end portions 16 include a first coil end portion 161 and a second coil end portion 162. The first coil end portion 161 protrudes from the end surface 4A of the stator core 4 to the one side in the axial direction. The second coil end portion 162 protrudes from the end surface 4B of the stator core 4 to the other side in the axial direction.

A pair of the terminal portions 17 is provided in each of the coils 5. The terminal portions 17 include a first terminal portion 171 and a second terminal portion 172. The first terminal portion 171 includes an end on a winding start side of the conductor 14. The second terminal portion 172 includes an end on a winding end side of the conductor 14. Note that a second terminal portion 172 may include an end on a winding start side of a conductor 14, and a first terminal portion 171 may include an end on a winding end side of the conductor 14.

In the embodiment, both of the first terminal portion 171 and the second terminal portion 172 are arranged on the one side in the axial direction of the end surface 4A. That is, both of the first terminal portion 171 and the second terminal portion 172 protrude in the circumferential direction from the first coil end portion 161. The first terminal portion 171 is arranged on the inner side in the radial direction of the coil 5. The second terminal portion 172 is arranged on the outer side in the radial direction of the coil 5. The first terminal portion 171 protrudes from the first coil end portion 161 to the one side in the circumferential direction. The second terminal portion 172 protrudes from the first coil end portion 161 to the other side in the circumferential direction.

The non-mounted teeth 12 are respectively arranged next to the coils 5 in the circumferential direction. The terminal portion 17 protrudes in the circumferential direction from the coil end portion 16 in such a manner as to overlap with at least a part of one of the non-mounted teeth 12 in the axial direction. That is, a position of the terminal portion 17 and a position of at least a part of the non-mounted tooth 12 are equal in the circumferential direction. The terminal portion 17 and at least a part of the non-mounted tooth 12 are arranged in a manner of being separated from each other in the axial direction. The first terminal portion 171 protrudes from the first coil end portion 161 to the one side in the circumferential direction in such a manner as to overlap with at least a part of an adjacent non-mounted tooth 12 next to one side in the circumferential direction of the coil 5. The second terminal portion 172 protrudes from the first coil end portion 161 to the other side in the circumferential direction in such a manner as to overlap with at least a part of a non-mounted tooth 12 next to the other side in the circumferential direction of the coil 5.

As illustrated in FIG. 4, in the axial direction, a distance Ga between an end 17E on the one side in the axial direction of the terminal portion 17 and the end surface 4A of the stator core 4 is equal to or shorter than a distance Gb between an end 16E on the one side in the axial direction of the first coil end portion 161 and the end surface 4A of the stator core 4. That is, a position of the end 17E of the terminal portion 17 is the same as a position of at least a part of the first coil end portion 161 in the axial direction. The terminal portion 17 is arranged in such a manner as not to protrude from the first coil end portion 161 to the one side in the axial direction.

In the embodiment, the distance Ga between the end 17E and the end surface 4A is equal to the distance Gb between the end 16E and the end surface 4A.

The terminal portion 17 has an opening 18. The opening 18 is formed in such a manner as to penetrate an inner surface of the terminal portion 17, which surface faces the inner side in the radial direction, and an outer surface of the terminal portion 17 which surface faces the outer side in the radial direction.

The motor 1 is a three-phase motor. The coil 5 includes a U-phase coil 5U, a V-phase coil 5V, and a W-phase coil 5W. In the embodiment, 12 coils 5 are provided. Four U-phase coils 5U are provided. Four V-phase coils 5V are provided. Four W-phase coils 5W are provided.

One V-phase coil 5V is arranged next to the one side in the circumferential direction of the U-phase coil 5U. One W-phase coil 5W is arranged next to the one side in the circumferential direction of the V-phase coil 5V. One U-phase coil 5U is arranged next to the one side in the circumferential direction of the W-phase coil 5W. A pair of the U-phase coils 5U is arranged in such a manner as to face each other in the radial direction. A pair of the V-phase coils 5V is arranged in such a manner as to face each other in the radial direction. A pair of the W-phase coils 5W is arranged in such a manner as to face each other in the radial direction.

<Connecting Wire>

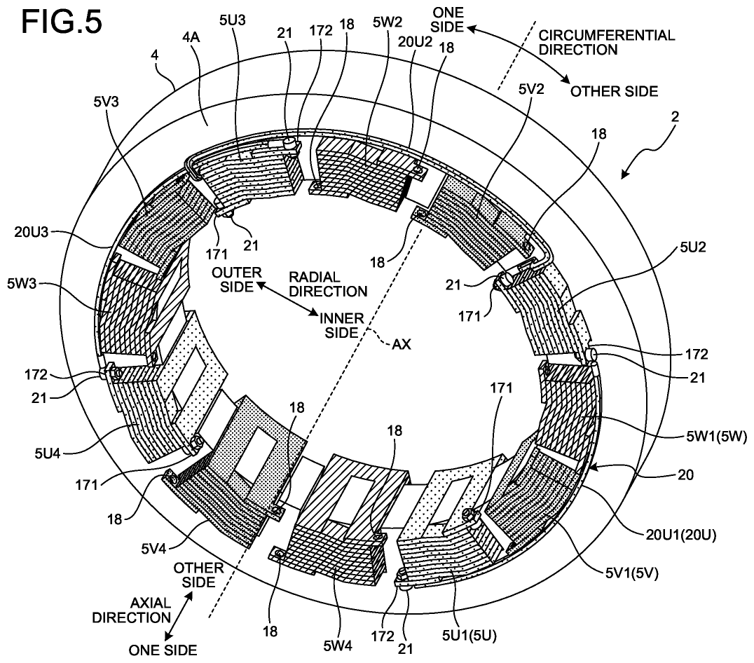

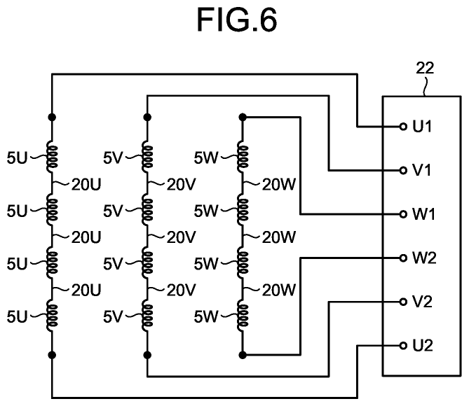

FIG. 5 is a perspective view illustrating the stator 2, in which connecting wires 20 are provided, according to the embodiment. FIG. 6 is a view schematically illustrating a connection state of the coils 5 according to the embodiment. As illustrated in FIG. 5 and FIG. 6, the stator 2 includes the connecting wires 20 that connect the coils 5 to each other. In the embodiment, the connecting wires 20 include U-phase connecting wires 20U that connect the plurality of U-phase coils 5U, V-phase connecting wires 20V that connect the plurality of V-phase coils 5V, and W-phase connecting wires 20W that connect the plurality of W-phase coils 5W. In FIG. 5, a state in which the four U-phase coils 5U are connected via the U-phase connecting wires 20U is illustrated, and illustration of the V-phase connecting wires 20V and illustration of the W-phase connecting wires 20W are omitted. As illustrated in FIG. 6, the plurality of coils 5 has an open winding structure in which end points of the U-phase coils 5U, end points of the V-phase coils 5V, and end points of the W-phase coils 5W are not coupled.

The connecting wires 20 are wire-shaped conductors that connect the plurality of coils 5. The connecting wires 20 are connected to the terminal portion 17.

In the embodiment, the four U-phase coils 5U are connected in series via the U-phase connecting wires 20U. The four V-phase coils 5V are connected in series via the V-phase connecting wires 20V. The four W-phase coils 5W are connected in series via the W-phase connecting wires 20W.

As illustrated in FIG. 5, the U-phase coils 5U include a first U-phase coil 5U1, a second U-phase coil 5U2, a third U-phase coil 5U3, and a fourth U-phase coil 5U4. The second U-phase coil 5U2 is arranged on the one side in the circumferential direction of the first U-phase coil 5U1. The third U-phase coil 5U3 is arranged on the one side in the circumferential direction of the second U-phase coil 5U2. The fourth U-phase coil 5U4 is arranged on the one side in the circumferential direction of the third U-phase coil 5U3.

The V-phase coils 5V include a first V-phase coil 5V1, a second V-phase coil 5V2, a third V-phase coil 5V3, and a fourth V-phase coil 5V4. The second V-phase coil 5V2 is arranged on the one side in the circumferential direction of the first V-phase coil 5V1. The third V-phase coil 5V3 is arranged on the one side in the circumferential direction of the second V-phase coil 5V2. The fourth V-phase coil 5V4 is arranged on the one side in the circumferential direction of the third V-phase coil 5V3.

The W-phase coils 5W include a first W-phase coil 5W1, a second W-phase coil 5W2, a third W-phase coil 5W3, and a fourth W-phase coil 5W4. The second W-phase coil 5W2 is arranged on the one side in the circumferential direction of the first W-phase coil 5W1. The third W-phase coil 5W3 is arranged on the one side in the circumferential direction of the second W-phase coil 5W2. The fourth W-phase coil 5W4 is arranged on the one side in the circumferential direction of the third W-phase coil 5W3.

The second terminal portion 172 of the first U-phase coil 5U1 and the second terminal portion 172 of the second U-phase coil 5U2 are connected via a first U-phase connecting wire 20U1. The first terminal portion 171 of the second U-phase coil 5U2 and the first terminal portion 171 of the third U-phase coil 5U3 are connected via a second U-phase connecting wire 20U2. The second terminal portion 172 of the third U-phase coil 5U3 and the second terminal portion 172 of the fourth U-phase coil 5U4 are connected via a third U-phase connecting wire 20U3.

A part of the first U-phase connecting wire 20U1 is arranged on the outer side in the radial direction of each of the first U-phase coil 5U1, the first V-phase coil 5V1, and the first W-phase coil 5W1. The first V-phase coil 5V1 is arranged next to the one side in the circumferential direction of the first U-phase coil 5U1.

The first W-phase coil 5W1 is arranged next to the one side in the circumferential direction of the first V-phase coil 5V1. The first U-phase connecting wire 20U1 is arranged in such a manner as to face the end surface 4A.

A part of the second U-phase connecting wire 20U2 is arranged on the outer side in the radial direction of each of the second V-phase coil 5V2, the second W-phase coil 5W2, and the third U-phase coil 5U3. The second V-phase coil 5V2 is arranged next to the one side in the circumferential direction of the second U-phase coil 5U2.

The second W-phase coil 5W2 is arranged next to the one side in the circumferential direction of the second V-phase coil 5V2. The third U-phase coil 5U3 is arranged next to the one side in the circumferential direction of the second W-phase coil 5W2. The second U-phase connecting wire 20U2 is arranged in such a manner as to face the end surface 4A.

A part of the third U-phase connecting wire 20U3 is arranged on the outer side in the radial direction of each of the third U-phase coil 5U3, the third V-phase coil 5V3, and the third W-phase coil 5W3. The third V-phase coil 5V3 is arranged next to the one side in the circumferential direction of the third U-phase coil 5U3. The third W-phase coil 5W3 is arranged next to the one side in the circumferential direction of the third V-phase coil 5V3. The third U-phase connecting wire 20U3 is arranged in such a manner as to face the end surface 4A.

The U-phase connecting wires 20U are supported by the end surface 4A via an insulator (not illustrated). Each of the V-phase connecting wires 20V and the W-phase connecting wires 20W is also supported by the end surface 4A.

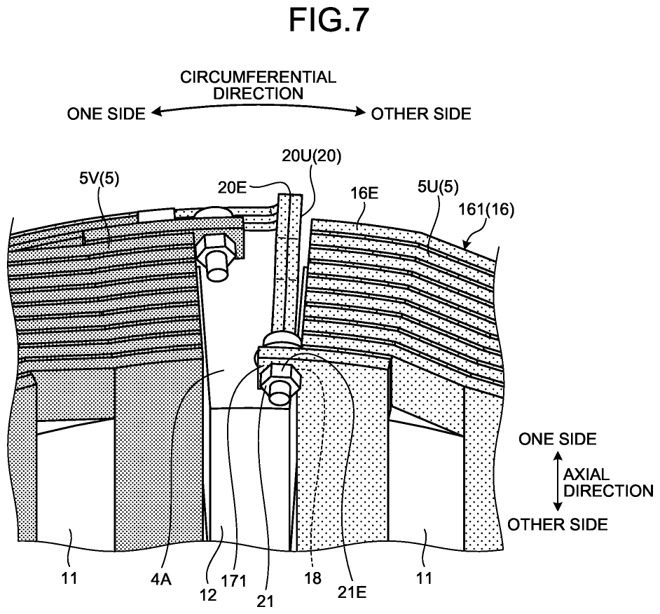

FIG. 7 is an enlarged view of a part of the stator 2, in which the connecting wires 20 are provided, according to the embodiment. A part of the stator 2 as viewed from the inner side in the radial direction is illustrated in FIG. 7. The connecting wire 20 fixed to the first terminal portion 171 is illustrated in FIG. 7. As illustrated in FIG. 5 and FIG. 7, the stator 2 includes a fixing member 21 that fixes each of the terminal portions 17 and each of the connecting wires 20. Examples of the fixing member 21 include a bolt and a nut. A part of the connecting wire 20 is arranged in the opening 18 of the terminal portion 17. In a state in which a part of the connecting wire 20 is arranged in the opening 18, the terminal portion 17 and the connecting wire 20 are fixed by the fixing member 21.

In the axial direction, a distance between an end 21E on the one side in the axial direction of the fixing member 21 and the end surface 4A of the stator core 4 is equal to or shorter than a distance between the end 16E on the one side in the axial direction of the first coil end portion 161 and the end surface 4A of the stator core 4. That is, a position of the end 21E of the fixing member 21 is the same as a position of at least a part of the first coil end portion 161 in the axial direction. The fixing member 21 is arranged in such a manner as not to protrude from the first coil end portion 161 to the one side in the axial direction.

In the axial direction, a distance between an end 20E on the one side in the axial direction of the connecting wire 20 and the end surface 4A of the stator core 4 is equal to or shorter than a distance between the end 16E on the one side in the axial direction of the first coil end portion 161 and the end surface 4A of the stator core 4. That is, a position of the end 20E of the connecting wire 20 and a position of at least a part of the first coil end portion 161 are the same in the axial direction. The connecting wire 20 is arranged in such a manner as not to protrude from the first coil end portion 161 to the one side in the axial direction.

<Operation>

As illustrated in FIG. 6, each of the U-phase coils 5U, the V-phase coils 5V, and the W-phase coils 5W is connected to a power source 22. The power source 22 supplies a drive current to the U-phase coils 5U via the U-phase connecting wires 20U. The power source 22 supplies the drive current to the V-phase coils 5V via the V-phase connecting wires 20V. The power source 22 supplies the drive current to the W-phase coils 5W via the W-phase connecting wires 20W. When the drive current is supplied to the coils 5, a magnetic flux MF is generated in the mounted teeth 11. When the magnetic flux MF is generated in the mounted teeth 11 and a rotating magnetic field is generated in the stator 2, the rotor 3 rotates about the rotation axis AX.

<Effect>

As described above, according to the embodiment, the stator core 4 includes the mounted teeth 11 on which the coils 5 are mounted and the non-mounted teeth 12 on which the coils 5 are not mounted. Each of the coils 5 includes the coil end portion 16 that protrudes in the axial direction from the stator core 4, and the terminal portion 17 connected to the connecting wire 20 that connects the coils 5 to each other. The terminal portion 17 protrudes in the circumferential direction from the coil end portion 16 in such a manner as to overlap with at least a part of one of the non-mounted teeth 12 in the axial direction. Since the terminal portion 17 protrudes in the circumferential direction without protruding in the axial direction from the coil end portion 16, the size of the stator 2 in the axial direction is controlled. Thus, an increase in a size of the motor 1 is controlled.

Since the terminal portion 17 overlaps with the non-mounted tooth 12 in the axial direction, the terminal portion 17 and the connecting wire 20 are smoothly connected. Since the non-mounted tooth 12 is arranged next to the coil 5 in the circumferential direction, interference of the terminal portion 17 of the one coil 5 with the adjacent coil 5 is controlled.

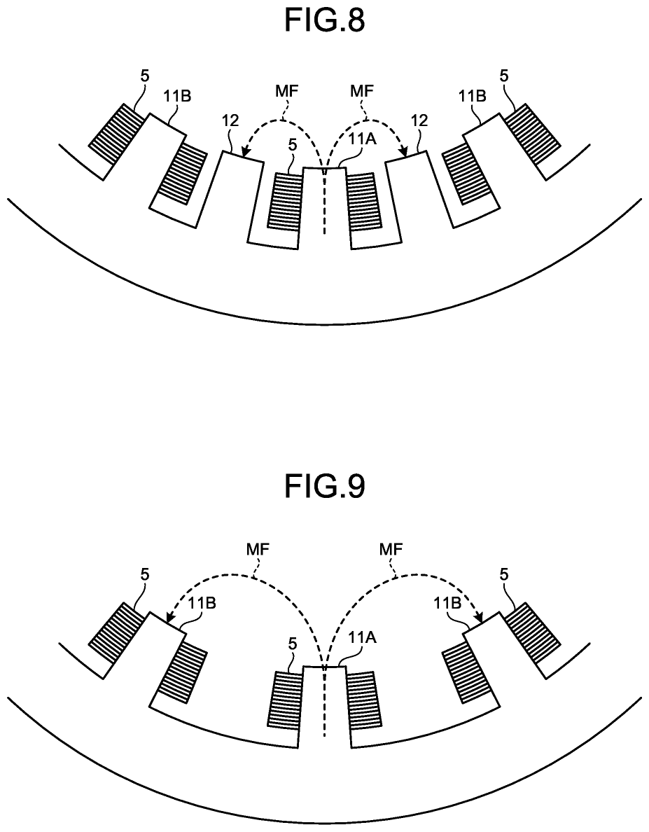

FIG. 8 is a schematic diagram illustrating a flow of the magnetic flux MF according to the embodiment. As illustrated in FIG. 8, since the non-mounted teeth 12 are arranged next to the coils 5 in the circumferential direction, there is a high possibility that the magnetic flux MF generated in a first mounted tooth 11A flows through the non-mounted teeth 12 next to the first mounted tooth 11A. Thus, the magnetic flux MF generated in the first mounted tooth 11A is prevented from flowing through a second mounted teeth 11B different from the first mounted tooth 11A.

FIG. 9 is a schematic diagram illustrating a flow of a magnetic flux MF according to a comparison example.

As illustrated in FIG. 9, in a case where non-mounted teeth 12 are not arranged next to coils 5, there is a high possibility that the magnetic flux MF generated in a first mounted tooth 11A flows through second mounted teeth 11B next to the first mounted tooth 11A. When the magnetic flux MF generated in the first mounted tooth 11A flows through the second mounted teeth 11B when a drive current is supplied to coils 5 mounted on the second mounted teeth 11B, a rotating magnetic field generated in a stator 2 may become unstable.

In the embodiment, the non-mounted teeth 12 are respectively arranged next to the coils 5 in the circumferential direction. Thus, the rotating magnetic field generated in the stator 2 is prevented from becoming unstable. Thus, a decrease in an output of the motor 1 is controlled.

In the axial direction, a distance Ga between the end 17E of each of the terminal portions 17 and the stator core 4 is equal to or shorter than the distance Gb between the end 16E of each of the coil end portions 16 and the stator core 4. Since the terminal portions 17 are arranged in such a manner as not to protrude in the axial direction compared to the coil end portions 16, the size of the stator 2 in the axial direction is controlled.

In the embodiment, the conductors 14 that form the coils 5 are the rectangular wires. The terminal portions 17 have a plate shape. In each of the terminal portions 17, the opening 18 penetrating the inner surface and the outer surface of the terminal portion 17 is formed. The plurality of coils 5 is provided separately. After each of the coils 5 is mounted on the mounted tooth 11, the terminal portion 17 and the connecting wire 20 are fixed by the fixing member 21. Thus, the stator 2 is smoothly manufactured.

In the embodiment, a winding method of the coils 5 is concentrated winding in which one coil 5 is mounted on one mounted tooth 11. The mounted teeth 11 and the non-mounted teeth 12 are alternately arranged one by one in the circumferential direction. Since the non-mounted teeth 12 are arranged on both sides in the circumferential direction of each of the mounted teeth 11, interference between the terminal portion 17 of the one coil 5 mounted on the mounted tooth 11 and the adjacent coil 5 is controlled. In addition, the non-mounted teeth 12 are arranged on both sides of each of the mounted teeth 11 in the circumferential direction. The magnetic flux MF generated in the mounted tooth 11 flows through each of the non-mounted teeth 12 arranged on the both sides in the circumferential direction. Thus, the rotating magnetic field generated in the stator 2 is prevented from becoming unstable. Thus, a decrease in an output of the motor 1 is controlled.

### Second Embodiment

The second embodiment will be described. In the following description, the same sign is assigned to a component same as or equivalent to that of the above-described embodiment, and a description thereof is simplified or omitted.

<Stator>

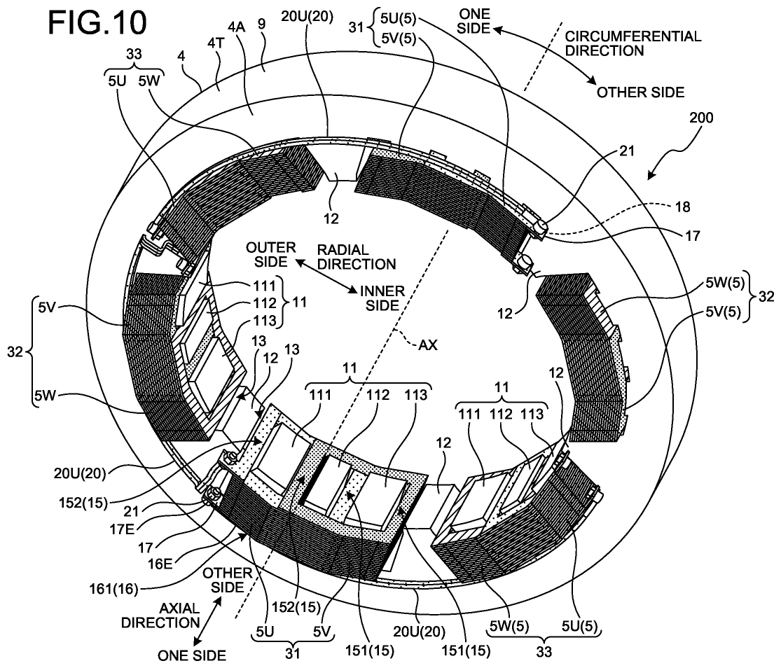

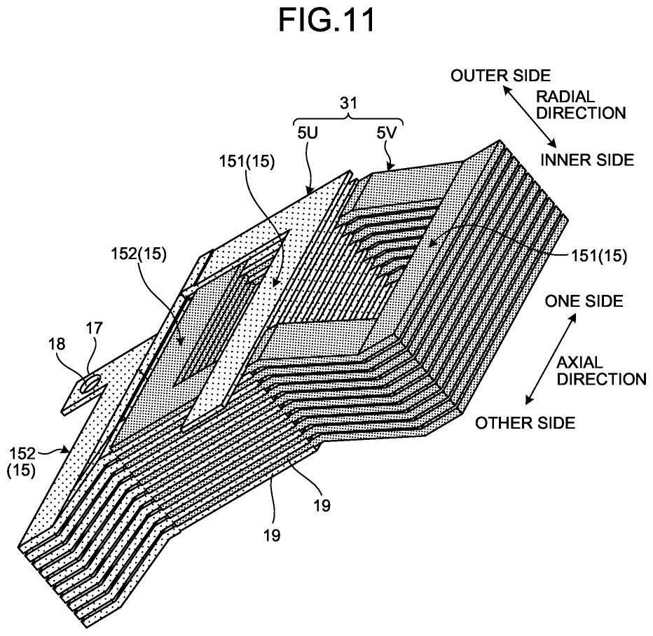

FIG. 10 is a perspective view illustrating a stator 200 according to the embodiment. A stator core 4 includes mounted teeth 11 and non-mounted teeth 12. A coil 5 includes a U-phase coil 5U, a V-phase coil 5V, and a W-phase coil 5W.

Three mounted teeth 11 are arranged in such a manner as to be adjacent to each other in a circumferential direction. The three mounted teeth 11 include a first mounted tooth 111, a second mounted tooth 112, and a third mounted tooth 113. The third mounted tooth 113 is arranged next to one side in the circumferential direction of the second mounted tooth 112. The second mounted tooth 112 is arranged next to one side in the circumferential direction of the first mounted tooth 111.

In the embodiment, three each of the mounted teeth 11 and one each of non-mounted teeth 12 are alternately arranged in the circumferential direction.

In the embodiment, a winding method of the coils 5 is distributed winding in which one coil 5 is mounted on a plurality of mounted teeth 11. In the embodiment, one coil 5 is mounted on two mounted teeth 11. That is, the coils 5 are mounted on the stator core 4 at a pitch of two slots. In a case where a first coil main body 151 is arranged in a predetermined slot 13, a second coil main body 152 is arranged in a slot 13 two slots away from the slot 13 in which the first coil main body 151 is arranged. Furthermore, the winding method of the coils 5 is a single layer winding in which one coil 5 is arranged in one slot 13. Each of the non-mounted teeth 12 is arranged between two coils 5 adjacent to each other in the circumferential direction.

The two coils 5 are mounted in an assembled state on the mounted teeth 11. The U-phase coil 5U and the V-phase coil 5V are mounted in the assembled state on the mounted teeth 11. The V-phase coil 5V and the W-phase coil 5W are mounted in the assembled state on the mounted teeth 11. The W-phase coil 5W and the U-phase coil 5U are mounted in the assembled state on the mounted teeth 11.

In the following description, a set of the U-phase coil 5U and the V-phase coil 5V is appropriately referred to as a coil set 31. A set of the V-phase coil 5V and the W-phase coil 5W is appropriately referred to as a coil set 32. A set of the W-phase coil 5W and the U-phase coil 5U is appropriately referred to as a coil set 33.

FIG. 11 is a perspective view illustrating the coil set 31 according to the embodiment. In the embodiment, the coils 5 include plate-shaped segment conductors 19. The coils 5 are formed by connection of the plurality of segment conductors 19 in a spiral shape. A part of the segment conductors 19 of the V-phase coil 5V is arranged between the segment conductors 19 of the U-phase coil 5U. A part of the segment conductors 19 of the U-phase coil 5U and a part of the segment conductors 19 of the V-phase coil 5V are alternately arranged in a radial direction. By arrangement of a part of the segment conductors 19 of the V-phase coil 5V between the segment conductors 19 of the U-phase coil 5U, the coil set 31 of the U-phase coil 5U and the V-phase coil 5V is formed.

Similarly, a part of the segment conductors 19 of the V-phase coil 5V and a part of the segment conductors 19 of the W-phase coil 5W are alternately arranged in the radial direction, whereby the coil set 32 of the V-phase coil 5V and the W-phase coil 5W is formed. A part of the segment conductors 19 of the W-phase coil 5W and a part of the segment conductors 19 of the U-phase coil 5U are alternately arranged in the radial direction, whereby the coil set 33 of the W-phase coil 5W and the U-phase coil 5U is formed. Each of the coil set 31, the coil set 32, and the coil set 33 is mounted on the stator core 4.

As illustrated in FIG. 10, in the coil set 31, the U-phase coil 5U is mounted on the first mounted tooth 111 and the second mounted tooth 112, and the V-phase coil 5V is mounted on the second mounted tooth 112 and the third mounted tooth 113. The segment conductors 19 of the U-phase coil 5U and the segment conductors 19 of the V-phase coil 5V are alternately arranged in the radial direction in a part of a periphery of the second mounted tooth 112.

In the coil set 32, the V-phase coil 5V is mounted on the first mounted tooth 111 and the second mounted tooth 112, and the W-phase coil 5W is mounted on the second mounted tooth 112 and the third mounted tooth 113. The segment conductors 19 of the V-phase coil 5V and the segment conductors 19 of the W-phase coil 5W are alternately arranged in the radial direction in a part of a periphery of the second mounted tooth 112.

In the coil set 33, the W-phase coil 5W is mounted on the first mounted tooth 111 and the second mounted tooth 112, and the U-phase coil 5U is mounted on the second mounted tooth 112 and the third mounted tooth 113. The segment conductors 19 of the W-phase coil 5W and the segment conductors 19 of the U-phase coil 5U are alternately arranged in the radial direction in a part of a periphery of the second mounted tooth 112.

Each of the coils 5 includes a coil end portion 16 that protrudes from the stator core 4 in an axial direction, and the terminal portion 17 connected to a connecting wire 20. The terminal portion 17 protrudes in the circumferential direction from the coil end portion 16 in such a manner as to overlap with at least a part of one of the non-mounted teeth 12 in the axial direction.

In the axial direction, a distance Ga between an end 17E on one side in the axial direction of the terminal portion 17 and an end surface 4A of the stator core 4 is equal to or shorter than a distance Gb between an end 16E on the one side in the axial direction of a first coil end portion 161 and the end surface 4A of the stator core 4.

The terminal portion 17 is arranged in such a manner as not to protrude from the first coil end portion 161 to the one side in the axial direction.

A part of the connecting wire 20 is arranged in an opening 18 formed in the terminal portion 17. The terminal portion 17 and the connecting wire 20 are fixed by a fixing member 21. In FIG. 10, a state in which four U-phase coils 5U are connected via U-phase connecting wires 20U is illustrated, and illustration of V-phase connecting wires 20V and W-phase connecting wires 20W are omitted.

The connecting wire 20 is arranged in such a manner as not to protrude from the first coil end portion 161 to the one side in the axial direction.

<Effect>

As described above, the terminal portions 17 protrude in the circumferential direction from the coil end portions 16 in such a manner as to overlap with at least a part of the non-mounted teeth 12. Since the terminal portions 17 protrude from the coil end portions 16 in the circumferential direction without protruding in the axial direction, a size of the stator 2 in the axial direction is controlled. Thus, an increase in a size of the motor 1 is controlled.

In the embodiment, the winding method of the coils 5 is distributed winding in which one coil 5 is mounted on two mounted teeth 11. Both a first-phase coil (such as U-phase coil 5U) and a second-phase coil (such as V-phase coil 5V) are mounted on the second mounted tooth 112. Thus, an increase in the size of the stator 2 is controlled.

The three mounted teeth 11 and the one non-mounted tooth 12 are alternately arranged in the circumferential direction. A magnetic flux MF generated in the mounted teeth 11 flows through the non-mounted tooth 12. Thus, a rotating magnetic field generated in the stator 2 is prevented from becoming unstable. Thus, a decrease in an output of the motor 1 is controlled.

In the embodiment, the segment conductors 19 of the first-phase coil (such as U-phase coil 5U) and a part of the segment conductors 19 of the second-phase coil (such as V-phase coil 5V) are alternately arranged in the radial direction. As a result, a size of the coil end portions 16 in the radial direction is controlled.

### Other Embodiments

In the above-described embodiment, it is assumed that a plurality of in-phase coils 5 is connected in series via the connecting wires 20. A plurality of in-phase coils 5 may be connected in parallel via a connecting wire 20. A plurality of coils 5 of different phases may be connected via a connecting wire 20.

In the above-described embodiments, it is assumed that the motor 1 is an inner rotor type in which the rotor 3 is arranged inside the stator core 4. The rotor 3 only needs to be arranged at a position facing the stator core 4. The motor 1 may be an outer rotor type in which a rotor 3 is arranged outside a stator core 4, a dual rotor type in which a rotor 3 is arranged on each of an inner side and outer side of a stator core 4, or an axial gap type in which a rotor 3 is arranged on a side of an axial direction of a stator core 4.

In the above-described embodiments, it is assumed that the motor 1 is a switched reluctance motor. The motor 1 may be a synchronous reluctance motor, a flux switching motor, a permanent magnet motor, an induction motor, an axial gap motor, or a linear actuator.

In the above-described embodiments, it is assumed that the motor 1 is a three-phase motor. The motor 1 may be a four-phase motor.

### REFERENCE SIGNS LIST

1 MOTOR
2 STATOR
3 ROTOR
4 STATOR CORE
4A END SURFACE
4B END SURFACE
4S INNER SURFACE
4T OUTER SURFACE
5 COIL
5U U-PHASE COIL
5U1 FIRST U-PHASE COIL
5U2 SECOND U-PHASE COIL
5U3 THIRD U-PHASE COIL
5U4 FOURTH U-PHASE COIL
5V V-PHASE COIL
5V1 FIRST V-PHASE COIL
5V2 SECOND V-PHASE COIL
5V3 THIRD V-PHASE COIL
5V4 FOURTH V-PHASE COIL
5W W-PHASE COIL
5W1 FIRST W-PHASE COIL
5W2 SECOND W-PHASE COIL
5W3 THIRD W-PHASE COIL
5W4 FOURTH W-PHASE COIL
6 ROTOR HOLDER
7 ROTOR CORE
8 ROTOR SHAFT
9 YOKE
10 TOOTH
11 MOUNTED TOOTH
11A FIRST MOUNTED TOOTH
11B SECOND MOUNTED TOOTH
12 NON-MOUNTED TOOTH
13 SLOT
14 CONDUCTOR
15 COIL MAIN BODY
16 COIL END PORTION
16E END
17 TERMINAL PORTION
17E END
18 OPENING
19 SEGMENT CONDUCTOR
20 CONNECTING WIRE
20E END
20U U-PHASE CONNECTING WIRE
20U1 FIRST U-PHASE CONNECTING WIRE
20U2 SECOND U-PHASE CONNECTING WIRE
20U3 THIRD U-PHASE CONNECTING WIRE
20V V-PHASE CONNECTING WIRE
20W W-PHASE CONNECTING WIRE
21 FIXING MEMBER
21E END
22 POWER SOURCE
31 COIL SET
32 COIL SET
33 COIL SET
111 FIRST MOUNTED TOOTH
112 SECOND MOUNTED TOOTH
113 THIRD MOUNTED TOOTH
151 FIRST COIL MAIN BODY
152 SECOND COIL MAIN BODY
161 FIRST COIL END PORTION
162 SECOND COIL END PORTION
171 FIRST TERMINAL PORTION
172 SECOND TERMINAL PORTION
200 STATOR
AX ROTATION AXIS
Ga DISTANCE
Gb DISTANCE
MF MAGNETIC FLUX
RS OBJECT

1. A stator comprising:
a stator core; and
coils, wherein
the stator core includes mounted teeth on which the coils are mounted and non-mounted teeth on which the coils are not mounted,
each of the coils includes a coil end portion that protrudes in an axial direction from the stator core, and a terminal portion connected to a connecting wire that connects the coils to each other, and
the terminal portion protrudes in a circumferential direction from the coil end portion in such a manner as to overlap with at least a part of the non-mounted teeth in the axial direction.

2. The stator according to claim 1, wherein
a distance between an end of the terminal portion and the stator core is equal to or shorter than a distance between an end of the coil end portion and the stator core in the axial direction.

3. The stator according to claim 1, wherein
the terminal portion has an opening in which the connecting wire is arranged, and
a fixing member that fixes the terminal portion and the connecting wire is further included.

4. The stator according to claim 1, wherein
one of the coils is mounted on one of the mounted teeth, and
the mounted teeth and the non-mounted teeth are alternately arranged one by one in the circumferential direction.

5. The stator according to claim 1, wherein
the coils include a first-phase coil and a second-phase coil,
three each of the mounted teeth are arranged in such a manner as to be adjacent to each other in the circumferential direction,
three each of the mounted teeth and one each of the non-mounted teeth are alternately arranged in the circumferential direction,
the first-phase coil is mounted on a first mounted tooth and a second mounted tooth, and
the second-phase coil is mounted on the second mounted tooth and a third mounted tooth.

6. The stator according to claim 5, wherein
a part of a conductor of the first-phase coil and a part of a conductor of the second-phase coil are alternately arranged in a radial direction.

7. A motor comprising:
the stator according to claim 1; and
a rotor that faces the stator core.
